(19) United States
(12) Patent Application Publication
(10) Pub. No.: US 2009/0181204 A1
(43) Pub. Date: Jul. 16, 2009

(54) Peelable laminate assembly, and method and apparatus for manufacturing the same

(75) Inventor: Kenichi Seguchi, Okaya-shi (JP)

Correspondence Address: EDWARDS ANGELL PALMER & DODGE LLP, P.O. BOX 55874, BOSTON, MA, 02205, US

(73) Assignee: Seiko Epson Corporation

(21) Appl. No.: 12/321,117

(22) Filed: Jan. 14, 2009

(30) Foreign Application Priority Data
Jan. 15, 2008 (JP) 2008-005319
Jan. 16, 2008 (JP) 2008-006511
Nov. 17, 2008 (JP) 2008-293108

(51) Int. Cl. B32B 7/06; B32B 37/14

(52) U.S. Cl. 428/41.8; 428/40.1; 156/182; 156/580

(57) ABSTRACT

A peelable laminate assembly includes at least two peelable laminates each including a first sheet and a second sheet bonded to one surface of the first sheet, the second sheet being peelable from the first sheet, and further includes a joint sheet for connecting the two adjacent peelable laminates, the joint sheet being bonded to one surface of each second sheet facing away from the corresponding first sheet.

### BACKGROUND

1. Technical Field

The present invention relates to a peelable laminate assembly, and a method and apparatus for manufacturing the same.

2. Related Art

In some cases, two sheets are peelably bonded to each other to form a peelable laminate, and one sheet is peeled from the peelable laminate and is then used. For example, to print a figure or characters on a fabric, such as a banner, using an ink jet printer, the figure or characters can be printed on a fabric sheet constituting a printing fabric, which includes a peelable back sheet bonded to one surface of the fabric sheet facing away from the printer.

In the use of such a printing fabric, even when the printer applies a tensile force for feeding to the fabric sheet, the fabric sheet hardly becomes distorted. Therefore, printing on the fabric sheet can be achieved with high accuracy. In addition, the back sheet absorbs an excess of ink for printing, thus preventing the excessive ink from spreading (refer to JP-A-8-311785).

When printing is performed on the above-described printing fabric which is unrolled or short, it is difficult to uniformly apply a tensile force for printing to the whole surface of the fabric sheet. Accordingly, the fabric may become distorted, thus leading to a distorted image printed on the fabric sheet. In general, therefore, the printing fabric which is long (i.e., in the form of a roll) is set in the printer, the printing fabric is subjected to continuous printing, and after that, a user cuts the printed fabric into segments each having a desired size.

However, cutting the printing fabric subjected to printing with, for example, scissors has a disadvantage in that fibers unravel from the cut end of the printing fabric. It is therefore necessary to cut the printing fabric with, for example, a melt cutter that cuts a fabric while melting the cut end of the fabric to prevent unraveling of the fabric. In this case, the melt cutter which is a large-scale facility is required. It is difficult for general users to set up such a facility.

As for a peelable laminate including two sheets peelably bonded to each other such that both ends of one sheet are aligned with those of the other sheet, disadvantageously, it is difficult to peel one sheet from the other sheet. For example, in the case of the above-described printing fabric, the user should peel the back sheet from the fabric sheet and then use the fabric sheet. However, it is difficult to peel the back sheet from the fabric sheet because the back sheet and the fabric sheet have the same size. In the case where the printing fabric is cut into segments with scissors, it is also difficult to peel the back sheet from the fabric sheet.

### SUMMARY

An advantage of some aspects of the invention is to provide an easy-to-manufacture assembly of peelable laminates which eliminate the need for cutting generally performed by a user after printing, to which a tensile force for printing can be uniformly applied, and in each of which one sheet is easily peeled from the other sheet.

According to an aspect of the invention, a peelable laminate assembly includes at least two peelable laminates each including a first sheet and a second sheet bonded to one surface of the first sheet, the second sheet being peelable from the first sheet, and includes a joint sheet for connecting the two adjacent peelable laminates, the joint sheet being bonded to one surface of each second sheet facing away from the corresponding first sheet.

In this case, the joint sheet may have an adhesive layer such that each adhesive layer segment extends from one end of the joint sheet bonded to one of the adjacent peelable laminates and protrudes from the end of the peelable laminate facing the other peelable laminate by a distance smaller than the thickness of the peelable laminate.

In this case, the gap between the two adjacent peelable laminates connected by the joint sheet may be smaller than the thickness of the peelable laminate.

Preferably, the joint sheet has a visible color, lightness, or transparency relative to the first sheet.

In this case, the joint sheet may be made of a material different from that of the first sheet or a material exhibiting a surface state different from that of the first sheet, alternatively, the joint sheet may have a surface state different from that of the first sheet.

In this case, the width of the peelable laminate may be larger than the length of the joint sheet.

The peelable laminate assembly may further include an anti-adhesion sheet disposed in the gap between the two adjacent peelable laminates connected through the joint sheet.

In this case, the peelable laminates may be cut in a standard size.

In this case, the first sheet may be a printing fabric.

According to another aspect of the invention, there is provided a method for manufacturing a peelable laminate assembly by bonding a joint sheet to at least two peelable laminates each including a first sheet and a second sheet peelably bonded to one surface of the first sheet. The method includes bonding the joint sheet to one surface of each second sheet facing away from the corresponding first sheet.

According to further another aspect of the invention, there is provided an apparatus for manufacturing an assembly of at least two peelable laminates each including a first sheet and a second sheet peelably bonded to one surface of the first sheet. The apparatus includes a unit that bonds a joint sheet to the two or more adjacent peelable laminates such that the joint sheet is bonded to one surface of each second sheet facing away from the corresponding first sheet.

### BRIEF DESCRIPTION OF THE DRAWINGS

The invention will be described with reference to the accompanying drawings, wherein like numbers reference like elements.

FIG. 1 is a perspective view of a printing fabric assembly according to an embodiment of the invention.

FIG. 2 is an enlarged cross-sectional view of the printing fabric assembly taken along the line II-II in FIG. 1.

FIG. 3 is a schematic diagram of a manufacturing apparatus according to an embodiment of the invention, the apparatus manufacturing the printing fabric assembly.

FIG. 4 is an enlarged cross-sectional view of a modification of the printing fabric assembly of FIG. 1.

FIG. 5 is an enlarged cross-sectional view of another modification of the printing fabric assembly of FIG. 1.

### DESCRIPTION OF EXEMPLARY EMBODIMENTS

Embodiments of the invention will be described below in the order of “1. Exemplary Configuration” according to an embodiment, “2. Manufacturing Apparatus” according to an embodiment, and “3. Modifications” of the embodiments.

### 1. Exemplary Configuration

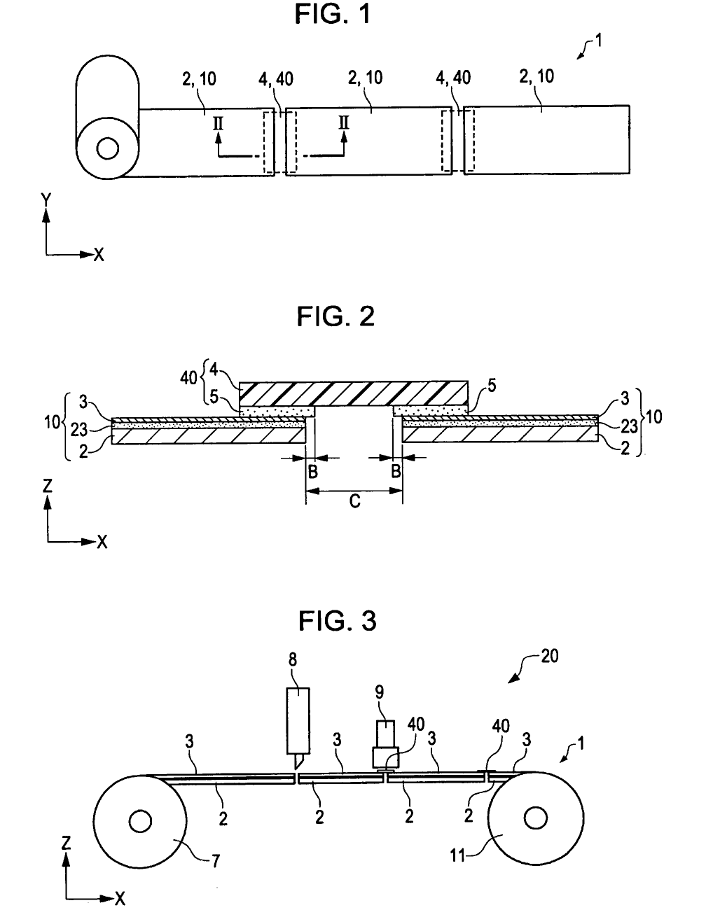

FIG. 1 illustrates a printing fabric assembly 1 as an example of a peelable laminate assembly according to an embodiment of the invention. FIG. 2 is an enlarged cross-sectional view of a joint portion of the printing fabric assembly 1 taken along the line II-II in FIG. 1.

The printing fabric assembly 1 according to the embodiment is elongated by connecting printing fabric segments (hereinafter, also referred to as “printing fabrics”) 10 arranged in the direction along the length of the printing fabric assembly 1, i.e., the X direction in FIG. 1 with joint sheets 40 such that each joint sheet 40 connects the two adjacent printing fabrics 10 as will be described later. The printing fabric assembly 1 is generally wound in the form of a roll. The printing fabric assembly 1 is drawn from the roll and is then subjected to printing. In this specification, the direction in which the fabric assembly is drawn from the roll will be called “X direction”.

In this specification, the printing fabric 10, serving as a peelable laminate, includes a fabric sheet 2 corresponding to a first sheet and a back sheet 3 corresponding to a second sheet such that the back sheet 3 is peelably bonded to one surface of the fabric sheet 2 with a temporary adhesive layer 23 therebetween.

A material for the fabric sheet 2 constituting the printing fabric 10 is not limited to a specific material. Various materials may be used as the fabric sheet 2. For example, the fabric sheet 2 is made of a natural fiber, such as cotton, silk, or wool, a regenerated fiber, such as acetate, rayon, or regenerated polyester, a synthetic fiber, such as nylon, polyurethane, or polyester, or a mixture of different fibers. The fabric sheet 2 is composed of a woven, knitted, or non-woven fabric mainly made of the above-described fiber or mixture. The fiber or mixture may be processed so that ink for ink jet printing is efficiently fixed to the fabric sheet. It is preferred that the printing fabrics 10 cut in a standard size (for example, 42×59.4 cm, 43×100 cm, or 61×180 cm) be prepared. Connecting the cut printing fabrics each having a standard size to form the printing fabric assembly remarkably improves user handling after printing.

A material for the back sheet 3 is not limited so long as the sheet has a thickness ranging from 20 to 500 μm and has such strength that the shape of the fabric sheet 2 can be kept. Various materials may be used as the back sheet 3. For example, a sheet of paper, such as glassine or wood free paper for processing, or a plastic sheet, such as polyethylene terephthalate (PET) or oriented polypropylene (OPP), may be preferably used. As for the plastic sheet, it is preferable to use a plastic sheet having excellent compatibility with an adhesive layer which will be described later because the strength of the adhesion (hereinafter, “adhesion strength”) between the back sheet 3 and a base 4 can be increased. When the back sheet 3 has an ink absorbing property, excessive ink can be absorbed during printing on the fabric sheet 2, so that the ink can be prevented from spreading after printing.

As for the temporary adhesive layer 23 which peelably fixes the back sheet 3 to the fabric sheet 2, the temporary adhesive layer 23 may be water-based or oil-based. Specifically, polyvinyl acetate, acrylic modified resin, ethylene-vinyl acetate copolymer, styrene-butadiene rubber (SBR) latex, polyvinyl alcohol, or starch may be used. The temporary adhesive layer 23 may be disposed on one surface of the fabric sheet 2 and the back sheet 3 may be then fixed to the fabric sheet 2 with the temporary adhesive layer 23 therebetween. Alternatively, the temporary adhesive layer 23 may be disposed on one surface of the back sheet 3 and the back sheet 3 may be then fixed to the fabric sheet 2 with the temporary adhesive layer 23 therebetween. Alternatively, the temporary adhesive layer 23 may be disposed on each of one surface of the fabric sheet 2 and that of the back sheet 3. To achieve clearer printing on the fabric sheet 2, it is preferred that the temporary adhesive layer 23 be disposed on one surface of the back sheet 3 alone and, after that, the fabric sheet 2 be attached to the back sheet 3 with the temporary adhesive layer 23 therebetween. Since the temporary adhesive layer 23 is disposed on the surface of the back sheet 3, the permeability of printing ink into the fabric sheet 2 hardly changes due to the temporary adhesive layer 23. Advantageously, the temporary adhesive layer 23 hardly affects the permeability of ink. When the temporary adhesive layer 23 has a high ink absorbing property, the printing fabric 10 exhibits high permeability of ink.

In this embodiment, assuming that each printing fabric 10 has a thickness of 0.1 cm in the Z direction, a width of 40 cm in the Y direction, and a length of 100 cm in the X direction, the rectangular printing fabrics 10 are connected such that each short end, extending in the Y direction, of one printing fabric 10 is opposed to the corresponding short end, extending in the Y direction, of the adjacent printing fabric 10. In addition, the bases 4 having a length of 35 cm in the Y direction in FIG. 1 and a width of 6 cm in the X direction are fixed to the back sheets 3 such that the long ends of each base 4 are attached to respective surfaces of the adjacent back sheets 3 facing away from the fabric sheets 2 with an adhesive layer 5 therebetween. The joint sheets 40 are bonded to the printing fabrics 10 such that the ends, extending in the Y direction, of the joint sheets 40 are substantially parallel to the ends, extending in the Y direction, of the printing fabrics 10. When a gap between the adjacent printing fabrics 10 is, for example, 2 cm, both ends of each joint sheet 40 overlap the corresponding printing fabrics 10 in the X direction by 2 cm, respectively. The joint sheet 40 is bonded to the printing fabrics 10 through the overlapping portions.

In this embodiment, each joint sheet 40 includes the base 4 and the adhesive layer 5 which is disposed on one surface of the base 4. As for the base 4 constituting the joint sheet 40, a sheet having a thickness of 500 μm or less may be preferably used. It is preferable to minimize the difference in thickness, i.e., dimension in the Z direction between a portion, to which the base 4 is bonded, of the printing fabric assembly 1 and a portion, to which the base 4 is not bonded, thereof. Minimizing the difference in dimension in the Z direction between these portions, namely, minimizing step portions of the printing fabric assembly 1 can reduce the occurrence of traces on the surface of the printing fabric assembly 1 caused by the difference between pressures applied to the surface thereof upon winding the printing fabric assembly 1 into a roll with a high tensile force and can also allow the printing fabric assembly 1 to be easily wound into the roll. As for a material for the joint sheet 40, it is preferable to use a material that is distortion-resistant against a tensile force applied in each manufacturing step. Furthermore, it is preferred that the base 4 be capable of flexibly following the motion of the printing fabric 10 and be made of a material having a high tensile strength.

As for the adhesive layer 5 disposed on one surface of the base 4, a material for the layer is not limited so long as the adhesive layer 5 can bond the base 4 to the back sheet 3. The adhesive layer 5 may include an adhesive made of resin, such as acryl, epoxy, urethane, polyethylene, polyester, alkyd, or amino, vinyl chloride resin, silicone resin, or fluorocarbon resin. Alternatively, a commercially available double-sided adhesive tape or a high-adhesion baseless film may be used. For the above-described reasons, it is preferred that the adhesive layer 5 be thin.

It is preferred that the adhesion strength between the base 4 and the back sheet 3 be higher than that between the back sheet 3 and the fabric sheet 2. The higher the adhesion strength between the base 4 and the back sheet 3, it is more preferable. Providing that the case where the above-described relationship between the adhesion strengths is satisfied, when the base 4 is removed, the back sheet 3 is also removed from the fabric sheet 2 together with the base 4. Accordingly, the back sheet 3 can be easily peeled from the fabric sheet 2. If the adhesion strength between the back sheet 3 and the base 4 is lower than that between the back sheet 3 and the fabric sheet 2, it is difficult to peel the back sheet 3 from the fabric sheet 2. The reason is as follows. When the back sheet 3 is removed while the base 4 is being grasped, the base 4 is removed from the back sheet 3 before the back sheet 3 is peeled from the fabric sheet 2. To increase the adhesion strength between the base 4 and the back sheet 3, a heat-sensitive or pressure-sensitive adhesive suitable for the material of the base 4 and that of the back sheet 3 may be used, alternatively, the area of adhesion between the base 4 and the back sheet 3 may be increased.

If the base 4 is easy to break or is made of an expandable material, such as rubber, a tension is not uniformly applied to the printing fabric assembly 1 during printing through a printer, thus affecting image quality. Therefore, the base 4 is preferably a film made of various synthetic resins, such as polyethylene terephthalate, polybutylene terephthalate, polycarbonate, polyarylate, polyester, polyolefin, and polyvinyl chloride.

Furthermore, to easily determine the boundary between each base 4 and the corresponding fabric sheet 2, it is preferable to color the base 4 so that the base 4 is visually distinguished from the fabric sheet 2. For example, assuming that the fabric sheet 2 is white in this embodiment, the base 4 is colored red, so that the boundary between the base 4 and the fabric sheet 2 is easily determined. A method of distinguishing the base 4 from the fabric sheet 2 is not limited to coloring. The base 4 and the fabric sheet 2 may have different patterns. To take a processing step, e.g., printing on the printing fabrics 10 into consideration, the color of the base 4 is set to black or a transparent color. Thus, the printer can easily detect the leading edge of each printing fabric 10.

In this embodiment, there is no segment of the adhesive layer 5 in the area between the two connected printing fabrics 10. Preferably, two adhesive layer segments of the adhesive layer 5 are arranged such that each adhesive layer segment extends from one end of the joint sheet bonded to one of the adjacent printing fabrics 10 and protrudes from the end of the corresponding printing fabric 10 toward the other printing fabric 10 by a distance B as shown in FIG. 2. The distance B in FIG. 2, namely, the distance where the adhesive layer segment extends from the end of the corresponding printing fabric 10 toward the other printing fabric 10 preferably ranges from zero to a value equivalent to the thickness of the printing fabric 10. In this embodiment, the printing fabric 10 has a thickness of 1 mm. So long as the distance B in FIG. 2 ranges from zero to 1 mm, the opposed ends of the adjacent printing fabrics 10 can be reliably fixed to the base 4. Consequently, the fabric sheet 2 is easily peeled from the back sheet 3. In addition, since the distance B is equal to or less than the thickness of the printing fabric 10, the printing fabrics 10 arranged in the thickness direction of the printing fabric 10 in the rolled printing fabric assembly 1 can be prevented from being bonded to the adhesive layers 5.

It is preferred that the adjacent printing fabrics 10 be not overlapped. The reason is as follows. When the distance between the adjacent printing fabrics 10 is zero or less, namely, the adjacent printing fabrics 10 overlap each other, the area of adhesion between the base 4 and each printing fabric 10 is reduced due to the overlapping. Disadvantageously, the back sheet 3 is easily separated from the base 4. In other words, when the adjacent printing fabrics 10 overlap each other, the area of adhesion between the base 4 and each back sheet 3 is small, so that the base 4 is peeled from the back sheet 3 before the fabric sheet 2 is peeled from the back sheet 3. Accordingly, it is difficult to peel the fabric sheet 2 from the back sheet 3.

In order to easily detect the position of each fabric sheet 2 in each step, such as printing, it is preferred that the edges, extending in the X direction, of each printing fabric 10 be positioned in the edge, extending in the X direction, of the printing fabric assembly 1. In addition, it is preferred that the bases 4 be not located in the long edges of the printing fabric assembly 1. Specifically, it is preferred that the dimension of the joint sheet 40 in the Y direction be at or below that of the printing fabric 10 in the Y direction. If the dimension in the Y direction of the printing fabric 10 is shorter than that of the joint sheet 40, the joint sheet 40 projects from both ends of the printing fabric assembly 1 in the Y direction, so that it is difficult to detect the edges, extending in the X direction, of the printing fabric 10 during printing. In addition, preferably, each outermost edge of the base 4 in the Y direction is located inside the corresponding outermost edge of the printing fabric 10 in the Y direction by a distance of several millimeters to several centimeters. Since the edges, extending in the X direction, of the base 4 are located inside the edges, extending in the X direction, of the printing fabric assembly 1, the back sheet 3 is more easily peeled from the fabric sheet 2. In addition, even when the joint sheet 40 is bonded such that the edges, extending in the X direction, of the joint sheet 40 are not substantially parallel to the edges, extending in the X direction, of the printing fabric assembly 1, the edges, extending in the X direction, of the base 4 can be prevented from projecting from the edges, extending in the X direction, of the printing fabric 10. When the base 4 does not project from the printing fabric 10 in the Y direction, one edge of the printing fabric 10 can be aligned with a sheet guide during printing on the printing fabric 10, thus preventing a printing trouble.

Since the above-described printing fabric 10 is a long product, a tensile force is easily uniformly applied to the printing fabric 10 during printing. Accordingly, there is a low possibility that printing will be performed while the fabric sheet 2 is distorted. Thus, high quality printing can be achieved. In particular, providing the printing fabric assembly 1 in the form of a roll permits the tensile force to be easily uniformly applied to the whole surface of each printing fabric 10. In addition, since the printing fabrics 10 are cut in a desired size, it is unnecessary for the user to cut the fabric sheet 2. Furthermore, since the user can peel the back sheet 3 from the fabric sheet 2 while grasping the base 4, the user can easily peel the back sheet 3 from the fabric sheet 2.

### 2. Manufacturing Apparatus

An apparatus for manufacturing the printing fabric assembly will be described below. FIG. 3 is a diagram explaining the configuration of a manufacturing apparatus 20 according to an embodiment of the invention, the apparatus 20 manufacturing the printing fabric assembly 1.

The manufacturing apparatus 20 for the printing fabric assembly 1 includes a supply reel 7, a melt cutter 8, a press machine 9, and a take-up reel 11.

The supply reel 7 is a unit that supplies the long printing fabric 10 from the rolled printing fabric 10. In this embodiment, the fabric sheet 2 faces below the apparatus (downward in FIG. 3). The printing fabric 10 is supplied while the back sheet 3 faces above the apparatus (upward in FIG. 3). The printing fabric 10 supplied from the supply reel 7 is cut into segments each having a desired length with the melt cutter 8 located above the printing fabric 10 in FIG. 3.

The melt cutter 8 functions as a cutting unit used in a cutting step of cutting the printing fabric 10. In this instance, the melt cutter 8 corresponds to a heat cutter which is heated at a temperature higher than the melting point of the fabric sheet 2 and that of the back sheet 3 and which cuts the printing fabric 10 while welding cut ends. When the cutting temperature is higher than the melting points of the fabric sheet 2 and the back sheet 3, the cut ends are excessively melted. When the cutting temperature is lower than the melting points of the fabric sheet 2 and the back sheet 3, the cut ends become thready. Therefore, it is preferable to use a heat cutter heated at a temperature higher than the melting points of the fabric sheet 2 and the back sheet 3 by approximately 10 to 100° C. In this embodiment, although the melt cutter 8 is downwardly moved up to a position where the melt cutter 8 is in contact with a target portion of the printing fabric 10, the melt cutter 8 is located above (away from) the printing fabric 10 so as not to affect the quality of the printing fabric 10 excluding the target portion. When a target object, such as the fabric sheet 2 or the back sheet 3, is resistant to melting, the melt cutter 8 may include a sharp melting blade so as to mechanically cut the fabric sheet 2 or the back sheet 3.

The press machine 9 functions as a bonding unit used in a base bonding step of bonding one joint sheet 40 to the adjacent back sheet segments, or sheets 3. The press machine 9 presses the joint sheet 40 against the printing fabric segments, or fabrics 10, so that the joint sheet 40 can be bonded to the back sheets 3.

The printing fabric assembly 1 obtained by connecting the printing fabrics 10 through the joint sheets 40 is wound into a roll by the take-up reel 11.

An operation of the manufacturing apparatus 20 for the printing fabric assembly 1 will now be described.

First, the supply reel 7 supplies the long printing fabric 10. At that time, the leading end of the printing fabric 10 is attached to the take-up reel 11. Although a speed for supply of the printing fabric 10 through the supply reel 7 is substantially the same as a speed for take-up of the printing fabric assembly 1 through the take-up reel 11, the take-up speed of the take-up reel 11 is faster than the supply speed because a predetermined gap is provided between the printing fabrics 10 upon connecting the fabrics. After supplying the printing fabric 10 by a predetermined amount, the supply reel 7 temporarily stops the supply of the printing fabric 10. The melt cutter 8, serving as the cutting unit, is moved from above the apparatus and a heated portion of the melt cutter 8 is then come into contact with the printing fabric 10, thereby cutting the printing fabric 10 while melting the fabric in the Y direction (cutting step).

Subsequently, the preceding printing fabric 10 is transported and the trailing end thereof is detected by a first end detector (not shown) located near the press machine 9. At that time, the transportation is stopped. The succeeding printing fabric 10 is transported until the leading end (formed by cutting) of the succeeding printing fabric 10 is detected by a second end detector (not shown) located upstream of the first end detector by a predetermined distance. Accordingly, the cut printing fabrics 10 are spaced at a predetermined distance from each other.

In the base bonding step, the joint sheet 40 including the adhesive layer 5 of a pressure-sensitive type is disposed in a predetermined position. At that time, the joint sheet 40 is placed such that the surface of the adhesive layer 5 in the joint sheet 40 faces the surface of the back sheet 3 facing away from the fabric sheet 2 in each printing fabric 10.

After that, the press machine 9 presses the joint sheet 40 against the printing fabrics 10. Consequently, a pressure-sensitive adhesive bonds the base 4 of the joint sheet 40 to the back sheets 3 (bonding step). In this embodiment, since the back sheets 3 face upward, a machine for supplying the base 4 and the press machine 9 are arranged above the back sheets 3. The printing fabrics 10 connected through the joint sheets 40 are wound into the roll through the take-up reel 11.

As described above, in this embodiment, the long printing fabric 10 is cut into segments, the adjacent printing fabric segments, or fabrics 10 are connected through the base 4 having the adhesive layer 5, and after that, the connected fabrics can be wound as the printing fabric assembly 1.

Since the rolled printing fabric assembly 1 formed in the above-described manner is long, a tensile force can be uniformly applied to the assembly during printing through a printer. In addition, the user cuts the base 4 connecting the adjacent printing fabrics 10, so that the user can separate a desired number of printing fabrics 10 from the rolled assembly. To peel each back sheet 3 from the corresponding printing fabric 10, the user grasps the base 4. Thus, the user can easily peel the back sheet 3 from the fabric sheet 2.

### 3. Modifications

The above-described embodiments are examples. Other various modifications can be made. For example, in the foregoing embodiment, the printing fabric assembly 1 includes the printing fabrics 10 arranged in the longitudinal direction of the assembly and the joint sheets 40 each connecting the adjacent printing fabrics 10. However, the printing fabric assembly 1 is not limited to this form. For example, it is unnecessary to bond the joint sheet 40, bonded to one printing fabric 10, to another printing fabric 10. The joint sheet 40 may be bonded to one or more ends of the printing fabric 10. The shape of the printing fabric (segment) 10 is not limited to a polygon having straight edges. The printing fabric (segment) 10 may have a shape having a curved edge, for example, a circle.

In the above-described embodiment, the melt cutter 8 is used for cutting the fabric sheet 2. The cutting unit is not limited to the melt cutter 8. Another unit, such as a laser cutter or an ultrasonic cutter, may be used. When the fabric sheet 2 has a high melting point, a step of applying an anti-raveling agent to cut ends, alternatively, a step of performing bias processing may be performed after the step of cutting the fabric sheet 2 using a normal cutter.

Although the above-described embodiments have been described with respect to the printing fabric assembly 1 as an example, the subject is not limited to the printing fabric so long as the subject is a peelable laminate. For example, a peelable laminate including an adhesive seal and a support may be used.

In the foregoing embodiment, the rolled printing fabric 10 is supplied to the manufacturing apparatus 20 for the printing fabric assembly. The manufacturing apparatus is not limited to this example. For example, the manufacturing apparatus 20 for the printing fabric assembly 1 may be configured such that the fabric sheet 2 and the back sheet 3 are supplied, the fabric sheet 2 is overlaid with the back sheet 3 while these sheets are temporarily bonded to each other, and after that, the bonded sheets are transported to be subjected to cutting. Alternatively, the manufacturing apparatus may be configured such that after the bonding step, the printing fabric assembly 1 may be subjected to printing and be then wound. Alternatively, to elongate the short printing fabric 10, the apparatus may include no cutting unit and be used to connect the short printing fabrics 10.

In the foregoing embodiment, the printing fabric 10 includes the fabric sheet 2 subjected to ink jet printing. Printing is not limited to ink jet printing. The printing fabric 10 may be subjected to printing by another printing method.

In the above-described embodiments, the printing fabrics (or fabric segments) 10 to be connected have substantially the same size. The printing fabric segments are not limited to the example. For example, the printing fabric segments 10 having different sizes may be connected. The printing fabric assembly 1 is not limited to the form in which the printing fabric segments are connected in the X direction. The printing fabric assembly 1 may include the printing fabric segments 10 connected in the Y direction.

In the embodiments, the printing fabric assembly 1 is wound into the roll. The form is not limited to the roll and the printing fabric assembly 1 may be managed in another form. For example, the printing fabric assembly 1 may be accordion-folded such that each base 4 is folded. However, it is more preferable to wind the long printing fabric assembly 1 into a roll and manage the rolled assembly. Thus, the printing fabric assembly 1 can be compactly managed without creasing the long printing fabric segments 10.

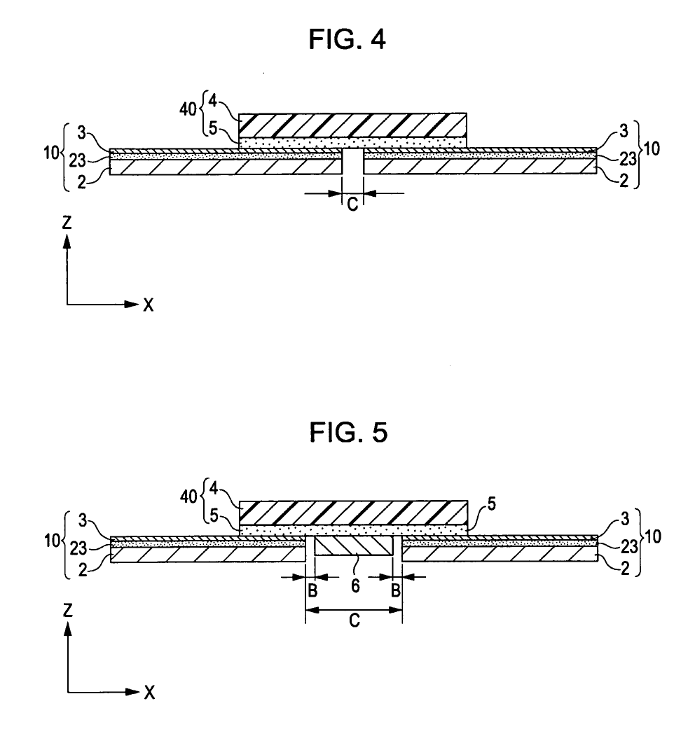

In the foregoing embodiment, in each joint sheet 40, the adhesive layer 5 is disposed such that the adhesive layer segments face the adjacent printing fabrics 10, respectively. The adhesive layer is not limited to this form. For example, when the gap (distance C) between the adjacent printing fabrics 10 to be connected is smaller than the thickness of the printing fabric 10 as shown in FIG. 4, the adhesive layer 5 may be disposed between the printing fabrics 10 to be connected. When the distance C is larger than the thickness of the printing fabric 10 as shown in FIG. 2, it is preferred to dispose an anti-adhesion sheet 6 as shown in FIG. 5. The anti-adhesion sheet 6 is disposed in order to prevent the adhesive layer 5 of each base 4 from adhering to another printing fabric 10 of the rolled printing fabric assembly 1. It is therefore preferred that the gap between one end of the anti-adhesion sheet 6 and the corresponding printing fabric 10 be smaller than the thickness of the printing fabric 10.

Although the dimensions of, for example, the fabric sheet 2 have been described using specific values in the foregoing embodiment, the dimensions or proportions are not limited to the examples. For instance, the area of the adhesive layer 5 of the joint sheet 40 may be increased or reduced depending on the adhesive force of the adhesive layer 5 per unit area.

Although the adhesive layer 5 of the joint sheet 40 is made of the pressure-sensitive adhesive in the foregoing embodiment, the adhesive layer 5 is not limited to the pressure-adhesive type. Another type adhesive layer may be used. For example, in the use of the heat-sensitive adhesive layer 5, a heating unit is used instead of the press machine 9 in order to bond the joint sheet to the back sheets 3.

In the foregoing embodiment, the surface of the base 4 facing the fabric sheet 2 is made of a material having higher slip characteristics than that of the fabric sheet 2. The material of the base 4 is not limited to this example. The surface of the base 4 facing the fabric sheet 2 may be made of a material having lower slip characteristics than that of the fabric sheet 2. However, assuming that the base 4 has a surface having a low coefficient of friction with a human being's finger and the fabric sheet 2 has a surface having a high coefficient of friction with the human being's finger, the user's finger smoothly slides on the joint sheet. When the finger reaches the fabric sheet 2 which serves as the first sheet, a high frictional resistance is generated between the finger and the sheet to be peeled. Thus, the first sheet can be easily peeled using the frictional resistance.

The invention is not limited to the foregoing embodiments and various changes and modifications could be made. For example, the invention may include substantially the same configuration as that explained in each embodiment (for example, the configuration having the same function, method, and result or having the same object and advantages as those of the embodiment). In addition, the invention may include a configuration in which nonessential portions in the configuration explained in the embodiment are replaced. The invention may include a configuration exhibiting the same advantages as those of the configuration explained in the embodiment or achieving the same object as that of the configuration explained in the embodiment. The invention may include a configuration obtained by adding a known art to the configuration explained in the embodiment.

The entire disclosure of Japanese Patent Application No: 2008-293108, filed Nov. 17, 2007 is expressly incorporated by reference herein.

What is claimed is:

1. A peelable laminate assembly comprising:
at least two peelable laminates each including
a first sheet, and
a second sheet bonded to one surface of the first sheet, the second sheet being peelable from the first sheet; and
a joint sheet for connecting the two adjacent peelable laminates, the joint sheet being bonded to one surface of each second sheet facing away from the corresponding first sheet.

2. The laminate assembly according to claim 1, wherein the joint sheet has an adhesive layer such that each adhesive layer segment extends from one end of the joint sheet bonded to one of the adjacent peelable laminates and protrudes from the end of the peelable laminate facing the other peelable laminate by a distance smaller than the thickness of the peelable laminate.

3. The laminate assembly according to claim 1, wherein the gap between the two adjacent peelable laminates connected by the joint sheet is smaller than the thickness of the peelable laminate.

4. The laminate assembly according to claim 1, wherein the joint sheet has a visible color, lightness, or transparency relative to the first sheet.

5. The laminate assembly according to claim 1, wherein the joint sheet is made of a material different from that of the first sheet or a material exhibiting a surface state different from that of the first sheet, alternatively, the joint sheet has a surface state different from that of the first sheet.

6. The laminate assembly according to claim 1, wherein the width of the peelable laminate is larger than the length of the joint sheet.

7. The laminate assembly according to claim 1, further comprising:
an anti-adhesion sheet disposed in the gap between the two adjacent peelable laminates connected through the joint sheet.

8. The laminate assembly according to claim 1, wherein the peelable laminates are cut in a standard size.

9. The laminate assembly according to claim 1, wherein the first sheet is a printing fabric.

10. A method for manufacturing a peelable laminate assembly by bonding a joint sheet to at least two peelable laminates each including a first sheet and a second sheet peelably bonded to one surface of the first sheet, the method comprising:
bonding the joint sheet to one surface of each second sheet facing away from the corresponding first sheet.

11. An apparatus for manufacturing an assembly of at least two peelable laminates each including a first sheet and a second sheet peelably bonded to one surface of the first sheet, the apparatus comprising:
a unit that bonds a joint sheet to the two or more adjacent peelable laminates such that the joint sheet is bonded to one surface of each second sheet facing away from the corresponding first sheet.
